(19) United States
(12) Patent Application Publication
(10) Pub. No.: US 2013/0018636 A1
(43) Pub. Date: Jan. 17, 2013

(54) QUADRATIC APPROXIMATE OFFSET CURVES FOR QUADRATIC CURVE SEGMENTS

(71) Applicant: Erik S. Ruf, Kirkland, WA (US)

(72) Inventor: Erik S. Ruf, Kirkland, WA (US)

(73) Assignee: Microsoft Corporation, Redmond, WA (US)

(21) Appl. No.: 13/182,453

(22) Filed: Jul. 14, 2011

(51) Int. Cl. G06F 17/17

(52) U.S. Cl. 703/2

(57) ABSTRACT

A system is described herein that produces at least one approximate offset curve that is separated by an original curve segment Sₒ by at least a distance d, thus defining a bounding region between the original curve segment Sₒ and the approximate offset curve. The original curve segment Sₒ and the approximate offset curve both have a quadratic form. In view of this quadratic form, the system can represent the approximate offset curve in an efficient manner (e.g., using three control points). Further, the system can perform calculations with respect to the approximate offset curve in an efficient manner.

### BACKGROUND

There sometimes arises a need to define a bounding region which extends from one or both sides of an original curve segment. Different approaches exist for defining such a bounding region with respect to an original curve segment. In one approach, an application can define a bounding region that has multiple components, such as multiple small polygonal bounding regions which encompass the original curve segment along the path of the original curve segment. In adopting this approach, this technique can typically produce a bounding region that has high fidelity with respect to the original curve segment. However, providing a precise bounding region comes at a cost, for reasons specified herein.

### SUMMARY

A system is described herein that produces at least one approximate offset curve that is separated from an original curve segment Sₒ by at least a distance d, thus defining a bounding region between the original curve segment Sₒ and the approximate offset curve. The original curve segment Sₒ and the approximate offset curve both have a quadratic form. In view of this quadratic form, the system can represent the approximate offset curve in an efficient manner (e.g., using three control points). Further, the system can perform calculations with respect to the approximate offset curve in an efficient manner.

More specifically, in one implementation, the system can generate the approximate offset curve by first constructing an original axis-symmetric control triangle based on the original curve segment Sₒ. The original axis-symmetric control triangle is symmetric with respect to the axis a of the parabola associated with the original curve segment Sₒ. The system then constructs a new control triangle by displacing the positions of control points associated with the original axis-symmetric control triangle in an outward or inward direction, where the new control triangle is also symmetric with respect to the axis a of the underlying parabola of the original curve segment Sₒ. The control points of the new control triangle define the quadratic approximate offset curve.

The system can perform any type of application-specific action based on the approximate offset curve. For example, in one application, the system can use at least one original curve segment and at least one corresponding approximate offset curve in generating a graphical image. In another application, the system can apply at least one original curve segment and at least one corresponding approximate offset curve in controlling the path of a machine. Other applications are possible.

The above approach can be manifested in various types of systems, components, methods, computer readable media, data structures, articles of manufacture, and so on.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows an illustrative system for producing and applying an approximate offset curve.

FIG. 2 is a flowchart that describes an overview of one manner of operation of the system of FIG. 1.

FIG. 3 is a flowchart that shows an illustrative manner of generating an original axis-symmetric control triangle.

FIG. 4 is a flowchart that shows an illustrative manner of generating a new control triangle by extending the control points of the axis-symmetric control triangle provided in FIG. 3.

FIG. 5 is a flowchart that shows an illustrative manner of applying an approximate offset curve.

FIG. 6 shows graphical depictions of curves and associated control triangles for use in illustrating the operations of FIG. 3.

FIG. 7 shows graphical depictions of curves and associated control triangles for use in illustrating the operations of FIG. 4.

FIG. 8 is a graphical depiction of one use of an approximate offset curve.

FIG. 9 is a graphical depiction of one use of two approximate offset curves.

FIG. 10 shows illustrative computing functionality that can be used to implement any aspect of the features shown in the foregoing drawings.

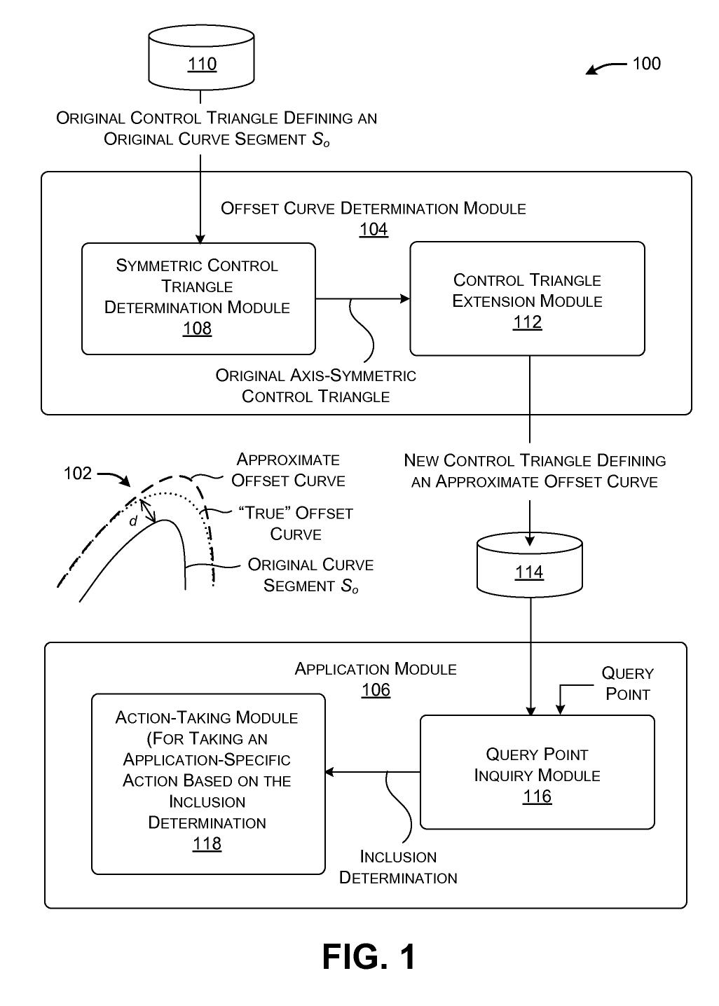

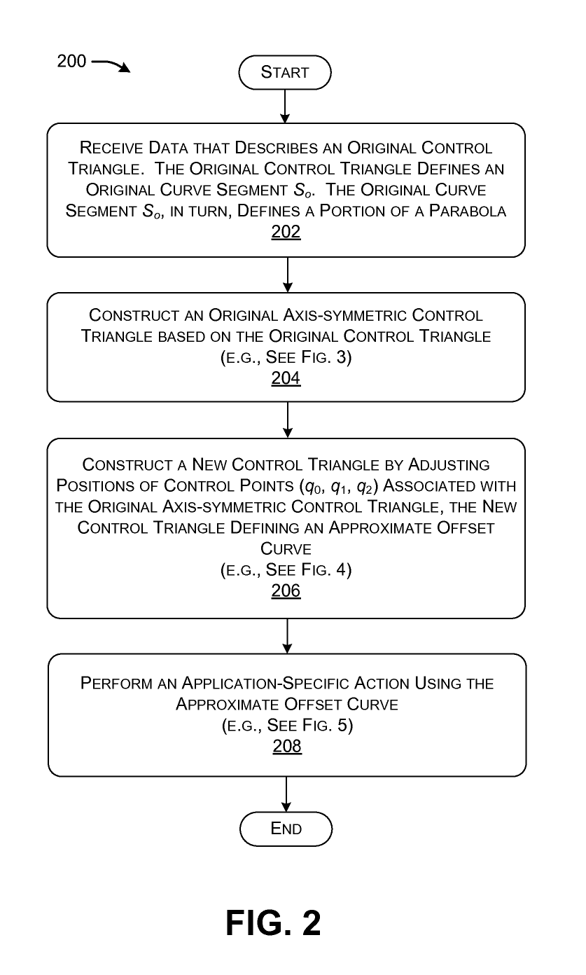

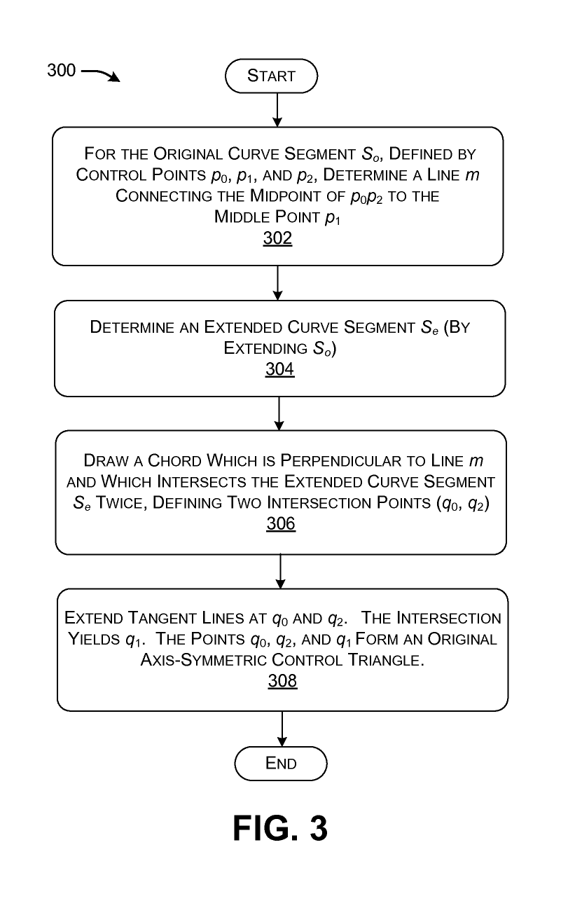

The same numbers are used throughout the disclosure and figures to reference like components and features. Series 100 numbers refer to features originally found in FIG. 1, series 200 numbers refer to features originally found in FIG. 2, series 300 numbers refer to features originally found in FIG. 3, and so on.

### DETAILED DESCRIPTION

This disclosure is organized as follows. Section A describes an illustrative system for generating and applying at least one approximate offset curve. Section B describes illustrative methods which explain the operation of the system of Section A. Section C describes illustrative computing functionality that can be used to implement any aspect of the features described in Sections A and B.

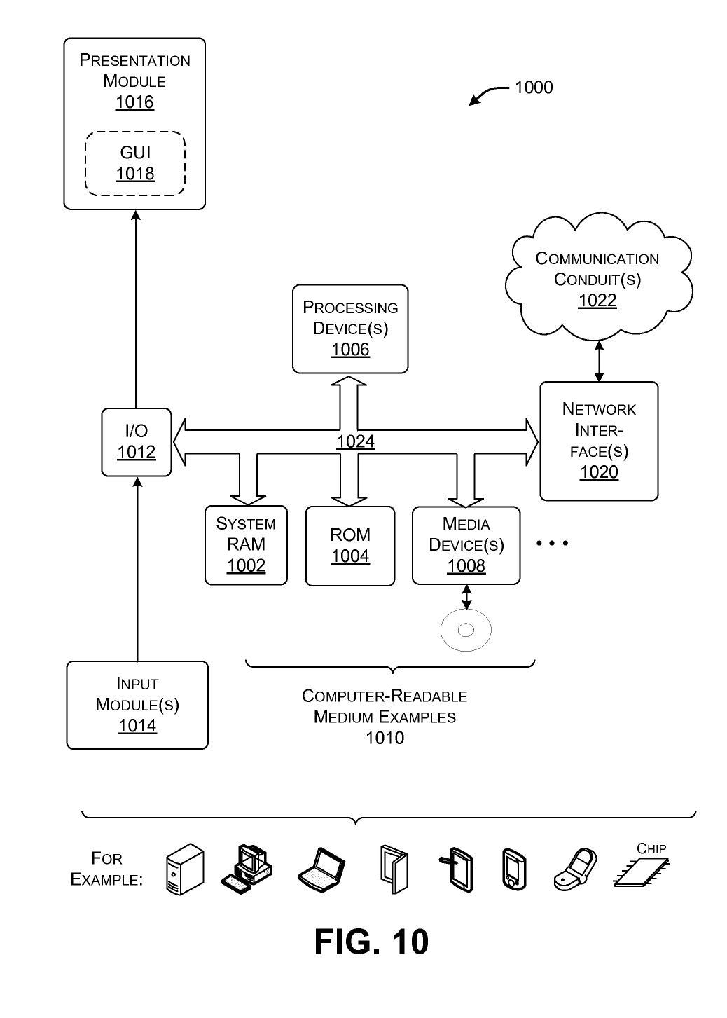

As a preliminary matter, some of the figures describe concepts in the context of one or more structural components, variously referred to as functionality, modules, features, elements, etc. The various components shown in the figures can be implemented in any manner by any physical and tangible mechanisms, for instance, by software, hardware (e.g., chip-implemented logic functionality), firmware, etc., and/or any combination thereof. In one case, the illustrated separation of various components in the figures into distinct units may reflect the use of corresponding distinct physical and tangible components in an actual implementation. Alternatively, or in addition, any single component illustrated in the figures may be implemented by plural actual physical components. Alternatively, or in addition, the depiction of any two or more separate components in the figures may reflect different functions performed by a single actual physical component. FIG. 10, to be discussed in turn, provides additional details regarding one illustrative physical implementation of the functions shown in the figures.

Other figures describe the concepts in flowchart form. In this form, certain operations are described as constituting distinct blocks performed in a certain order. Such implementations are illustrative and non-limiting. Certain blocks described herein can be grouped together and performed in a single operation, certain blocks can be broken apart into plural component blocks, and certain blocks can be performed in an order that differs from that which is illustrated herein (including a parallel manner of performing the blocks). The blocks shown in the flowcharts can be implemented in any manner by any physical and tangible mechanisms, for instance, by software, hardware (e.g., chip-implemented logic functionality), firmware, etc., and/or any combination thereof.

As to terminology, the phrase “configured to” encompasses any way that any kind of physical and tangible functionality can be constructed to perform an identified operation. The functionality can be configured to perform an operation using, for instance, software, hardware (e.g., chip-implemented logic functionality), firmware, etc., and/or any combination thereof.

The term “logic” encompasses any physical and tangible functionality for performing a task. For instance, each operation illustrated in the flowcharts corresponds to a logic component for performing that operation. An operation can be performed using, for instance, software, hardware (e.g., chip-implemented logic functionality), firmware, etc., and/or any combination thereof. When implemented by a computing system, a logic component represents an electrical component that is a physical part of the computing system, however implemented.

The following explanation may identify one or more features as “optional.” This type of statement is not to be interpreted as an exhaustive indication of features that may be considered optional; that is, other features can be considered as optional, although not expressly identified in the text. Finally, the terms “exemplary” or “illustrative” refer to one implementation among potentially many implementations

A. Illustrative System

FIG. 1 shows an illustrative system 100 for generating and applying an approximate offset curve. As shown in representation 102, the approximate offset curve is displaced at least a distance d from an original curve segment Sₒ at all points along the path of the approximate offset curve. More specifically, the approximate offset curve is considered “approximate” because it is an approximation of a hypothetical “true” offset curve. For any point on the original curve segment Sₒ, the distance to the nearest point on the true offset curve is exactly distance d. As shown, the approximate offset curve may extend farther than distance d from the original curve segment Sₒ at various points along the path of the approximate offset curve.

The system 100 includes an offset curve determination module 104 for generating the approximate offset curve. The system 100 also includes an application module 106 for applying the approximate offset curve to perform one or more application-specific actions. In one example, the offset curve determination module 104 and the application module 106 can be implemented by computing functionality, which, in turn, may be implemented by one or more computing devices. In the case in which plural devices are used, these devices can be provided at a single location or can be distributed over plural respective locations. Section C provides additional information on illustrative physical implementations of the computing functionality.

The offset curve determination module 104 can include (or can be conceptualized as including) plural components which perform different functional roles. A symmetric control triangle determination module 108 receives data that describes an original control triangle (e.g., from a data store 110 or some other source or sources). The original control triangle is defined with respect to three control points (p₀, p₁, p₂). These control points define the path of a quadratic Bezier curve, constituting the original curve segment Sₒ (where the control points p₀ and p₂ describe the endpoints of the original curve segment Sₒ). The symmetric control triangle determination module 108 determines an original axis-symmetric control triangle based on the original control triangle. Section B will provide additional information regarding the characteristics of the original axis-symmetric control triangle and the manner in which the original axis-symmetric control triangle can be derived. At this point, suffice it to say that the original curve segment Sₒ defines a portion of a parabola, and that parabola has an axis a (defining the axis which divides the parabola into two matching or mirror sides). The symmetric control triangle determination module 108 defines the original axis-symmetric control triangle such that it is symmetric with respect to the axis a of the parabola (meaning that the axis a divides the original axis-symmetric triangle into two mirror sides). That is, the original control triangle and the original axis-symmetric control triangle describe the same curve, but the original axis-symmetric control triangle is symmetric about the axis a. The original control triangle may or may not be symmetric with respect to the axis a.

A control triangle extension module 112 modifies the original axis-symmetric control triangle by displacing its control points (q₀, q₁, q₂) to produce new control points (q′₀, q′₁, q′₂). For example, in one case, the control triangle extension module 112 can displace the control points (q₀, q₁, q₂) in an outward direction to produce a larger control triangle than the original axis-symmetric control triangle. In another case, the control triangle extension module 112 can displace the control points (q₀, q₁, q₂) in an inward direction to produce a smaller control triangle than the original axis-symmetric control triangle. In either case, the control points (q′₀, q′₁, q′₂) define an approximate offset curve that corresponds to a quadratic Bezier curve segment. That is, both of the original curve segment Sₒ and the approximate offset curve have a quadratic form that can be represented by respective control triangles. As noted above, the approximate offset curve has the property that it is displaced from the original curve segment Sₒ by at least distance d along all points of the approximate offset curve.

In other cases, the offset curve determination module 104 can generate two approximate offset curves based on an original curve segment Sₒ. A first approximate offset curve lies at least a distance d from the outer side (e.g., the convex side) of the original curve segment Sₒ, and is produced by moving the control points (q₀, q₂) in an outward direction. A second approximate offset curve lies at least a distance d from the inner side (e.g., the concave side) of the original curve segment Sₒ, and is produced by moving the control points (q₀, q₂) in an inward direction.

In other cases, the offset curve determination module 104 can form one or more piecewise or composite approximate offset curves, where each such offset curve is composed, in turn, by two or more quadratic Bezier segments. Each segment is at least d distance from a portion of the original curve segment Sₒ which it respectively models.

The offset curve determination module 104 can store the control points (q′₀, q′₁, q′₂) which define an approximate offset curve in a data store 114. The approximate offset curve defines a bounding region that lies between the original curve segment Sₒ and the approximate offset curve. Alternatively, two approximate offset curves may bracket the original curve segment Sₒ, such that the bounding region lies to both sides of the original curve segment Sₒ.

The application module 106 can apply an approximate offset curve to achieve different purposes. In one general case, a query point inquiry module 116 can make a determination as to whether a query point lies within a bounding region defined by one or more approximate offset curves. An action-taking module 118 can then perform an analysis operation if the query point lies in the bounding region, such as by using any iterative distance-determination technique to determine a minimum distance between the query point and the original curve segment Sₒ. The action-taking module 118 can avoid performing this analysis if the query point lies outside the bounding region. Thus, overall, the application module 106 can leverage the bounding region to reduce the number of times it is required to perform the detailed analysis operation.

In one case, the application module 106 can produce a graphical image based on the analysis described above. For example, the application module 106 can apply an anti-aliasing operation to at least some of the pixels (corresponding to respective query points) that lie within the bounding region. More specifically, for a particular pixel, the application module 106 can determine whether the pixel's position lies within the bounding region. If so, the application module 106 can compute the minimum distance between the pixel and the original curve segment Sₒ, and use that distance to define a distance-based transparency value for that pixel. Note that the approximate offset curve is an approximation of the true offset curve, so some of the query points may actually lie outside an ideal bounding region which exists between the true offset curve and the original curve segment Sₒ (again note the representation 102 of FIG. 1). Hence, the application module 106 can avoid applying an anti-aliasing effect to these pixels that are determined to lie outside the ideal bounding region. The approximate offset curve identifies those points which cannot possibly lie within the true bounding region, and thereby serves to, overall, accelerate the anti-aliasing operation by eliminating the need for time-consuming distance calculation for these outlying points.

Alternatively, or in addition, the application module 106 can use an original curve segment Sₒ and two approximate offset curves to render a segment of a brushed path of width d, where the first approximate offset curve lies at a distance of at least +d/2 with respect to the original curve segment Sₒ, and the second approximate offset curve lies at a distance of at least −d/2 with respect to the original curve segment Sₒ. More specifically, for a particular pixel, the application module 106 can determine whether the pixel lies within the bounding region defined by the approximate offset curves. If so, the application module 106 can compute the minimum perpendicular distance between the pixel and the original curve segment Sₒ, and use that distance to define, using any arbitrary mapping function, a transverse parameter value for that pixel. For example, in one illustrative case, the application module 106 can assign normalized values of −1 and +1 to maximum perpendicular displacements from points along the original curve segment Sₒ (e.g., to either respective side of Sₒ), defining a brushed path region through which the original curve segment Sₒ runs at position 0. The application module 106 can assign a transverse parameter value to a query point based on its displacement from Sₒ within this normalized range (if, in fact, it lies within this range at all). In another case, a brushed path can be defined with respect to a single approximate curve and the original curve segment Sₒ.

In another scenario, the application module 106 can control the path of a machine based on the analysis described above. For example, the application module 106 can guide a vehicle or a manufacturing tool or some other apparatus along a physical path defined by one or more original curve segments. The application module 106 can use one or more approximate offset curves to approximate a range d of permissible deviation along that path. For a particular candidate position, the application module 106 can determine whether the position lies within a bounding region defined by one or more approximate offset curves. If so, the application module 106 can compute the minimum distance between the position and the original curve segment Sₒ, and use that distance to guide the machine, e.g., by controlling the machine so that its path more closely follows the original curve segment Sₒ.

Still other applications are possible. Generally, the application module 106 represents any type of mechanism that implements an application in a particular environment, and may encompass computing resources and/or mechanical resources.

In conclusion, the quadratic approximation curve represents a conservative estimate of the true offset curve. This is because, as shown in the representation 102, the approximate offset curve may diverge, at certain points, from the true offset curve by sweeping out farther than a distance d from the original curve segment Sₒ. This lack of precision is acceptable, however, because, in one implementation, the application module 106 uses the approximate offset curve as only an acceleration mechanism to reduce the amount of processing that is performed on a set of query points. That is, the lack of precision means that the application module 106 will perform detailed analysis on some query points that is not, strictly speaking, necessary (because these query points may lie more than distance d from the original curve segment Sₒ); but this unnecessary processing will not affect the integrity of the ultimate output of the application module 106.

At the same time, the system can generate, store, and apply the approximate offset curve in a highly efficient manner. This is because the approximate offset curve has a quadratic form that can be represented with only three control points. These efficiency-related benefits can ameliorate any additional processing associated with the use of an imprecise offset curve.

In contrast, consider the case of an application which uses multiple polygonal components to represent a precise boundary region (e.g., as described in the Background section). In one implementation, this application must consume time to create a data structure that describes the bounding region. And then the application must devote memory resources to store the data structure. Further, the application must devote sufficient processing resources to perform computations which involve the bounding region. These costs detract from the otherwise desirable goal of providing a bounding region which precisely follows the shape of the original curve segment.

B. Illustrative Processes

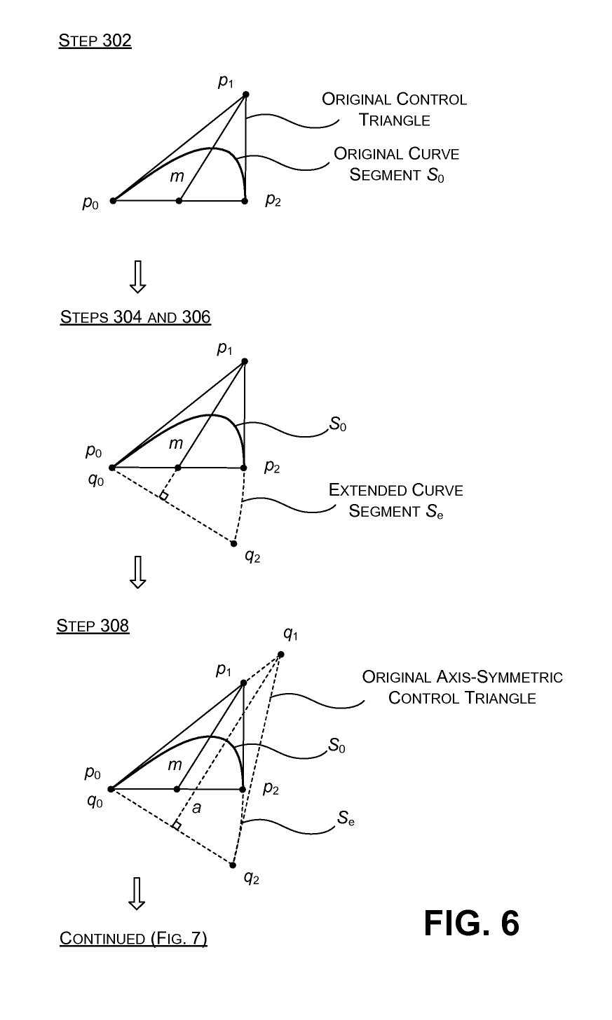

FIGS. 2-5 show procedures (200, 300, 400, 500) that explain one manner of operation of the system 100 of FIG. 1. These figures will be explained in conjunction with the illustrative graphical depictions in FIGS. 6-9.

Starting with FIG. 2, this figure shows a procedure 200 which represents an overview of one implementation of the system 100. In block 202, the system 100 receives data that describes an original control triangle. The original control triangle has three control points (p₀, p₁, p₂) that define an original curve segment Sₒ (based on the Bezier equation which uses the control points to define the path of the curve segment, i.e., B(t)=(1−t)² p₀+2(1−t)t p₁+t² p₂), where 0≦t≦1. These points also describe an infinite parabolic curve on which S₀ lies. Determination of whether a query point lies on, outside, or inside of this parabola can be performed by evaluating an implicit equation that is derivable from the control points. More specifically, every quadratic Bezier curve has an implicit equation b₁(p)²−4b₀(p)b₂(p)=0, where the bᵢ are the barycentric coordinates of point p with respect to the control triangle points pᵢ. The left-hand side of this equation can be used as a formula for determining whether a query point lies above, below, or on the original curve segment Sₒ.

In block 204, the system 100 constructs an original axis-symmetric control triangle based on the original control triangle. The original axis-symmetric control triangle is symmetric with respect to the axis a of the parabola defined by the original curve segment Sₒ. The original axis-symmetric control triangle is defined with respect to three control points (q₀, q₁, q₂). FIG. 3 provides additional details regarding the operation of block 204.

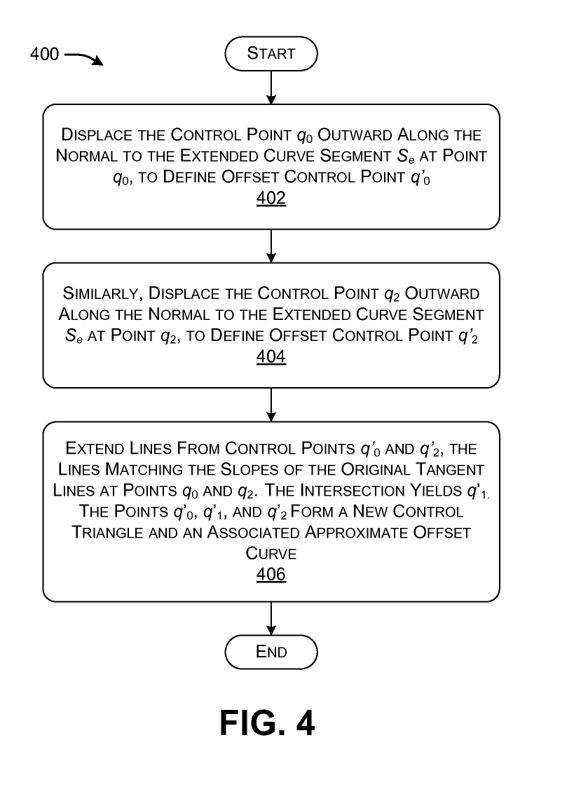

In block 206, the system 100 constructs a new control triangle by displacing the positions of the control points (q₀, q₁, q₂) of the original axis-symmetric control triangle in an inward or outward direction, yielding new control points (q′₀, q′₁, q′₂). The new control triangle defines a quadratic approximate offset curve which is at least distance d from the original curve segment Sₒ. FIG. 4 provides additional details regarding the operation of block 204.

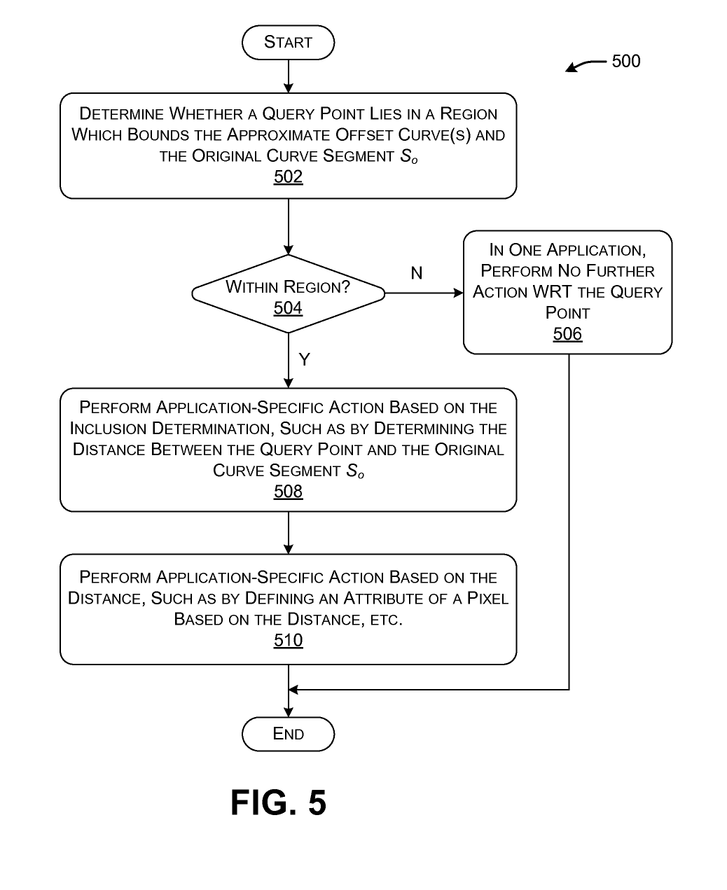

In block 208, the system performs an application-specific action based on the approximate offset curve that has been calculated in block 204. FIG. 5 provides additional details regarding the operation of block 208.

Advancing to FIG. 3, this figure explains one manner by which the system 100 can generate the original axis-symmetric control triangle (corresponding to block 204 of FIG. 2). This figure will be explained below with reference to the graphical depictions of FIG. 6. The procedure 300 is performed by operating on the control points (p₀, p₁, p₂) of the original control triangle, which, in turn, describes the original curve segment Sₒ.

In block 302, the system 100 defines a line segment p₀p₂ which connect the control points p₀ and p₂ of the original control triangle. The system 100 then defines a line m which runs from the midpoint of the line segment p₀p₂ to the control point p₁. This line m can be shown to be parallel to the axis a of the parabola which underlies the original curve segment Sₒ.

In block 304, the system 100 can extend the parabola associated with the original curve segment Sₒ to produce an extended curve segment Sₑ. More specifically, the original curve segment Sₒ represents just a portion of an infinite parabola. If necessary (for the purposes of the subsequent operation in block 306), block 304 extends one or more ends of the segment to show additional parts of the underlying parabola, producing an extended version of Sₒ.

In block 306, the system 100 next draws a chord which runs parallel to the line m (determined in block 302) and which intersects the extended curve segment Sₑ twice. There are an infinite number of chords which satisfy this constraint. In one implementation, the system 100 can draw a chord which intersects either the control point p₀ or the control point p₂. Doing so will create an approximate offset curve that preserves the tangent behavior of at least one of the endpoints of the original curve segment Sₒ. More specifically, the system 100 can draw the chord through whatever control point is farthest from the control point p₁. This choice helps reduce numerical problems for asymmetric curve segments having one endpoint very close to p₁. In any case, the two points at which the chord intersects the extended curve segment Sₑ define two control points (q₀, q₂) of the original axis-symmetric control triangle.

In block 308, the system 100 can extend lines which are tangent to Sₑ at the control points q₀ and q₂. The intersection of these lines defines the control point q₁. Taken together, the three control points (q₀, q₁, q₂) define the original axis-symmetric control triangle. This control triangle is symmetric in that, by folding it about the axis a, one side mirrors the other.

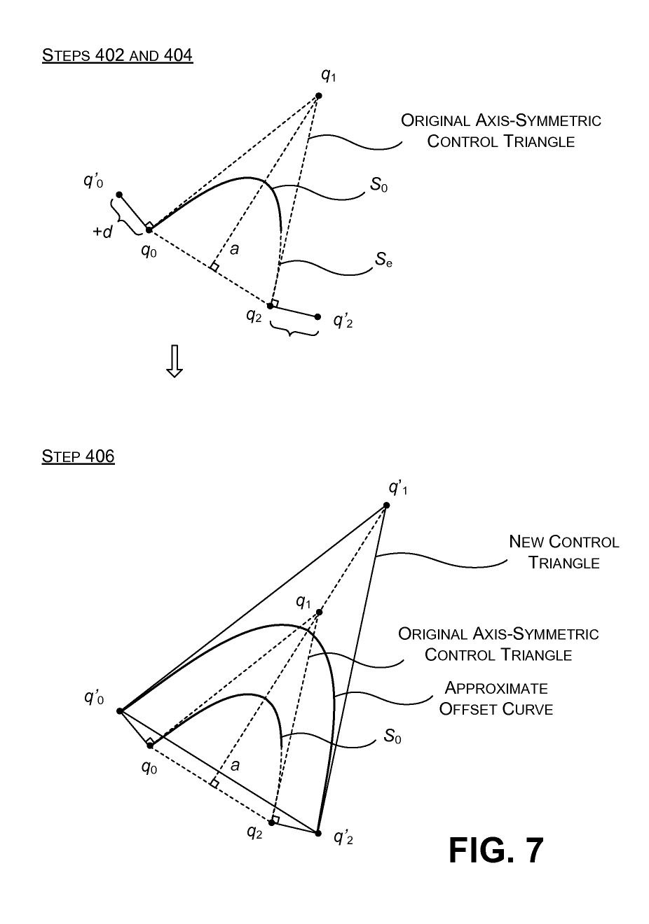

Advancing to FIG. 4, this figure explains one manner by which the system 100 can generate the new control triangle based on the original axis-symmetric control triangle (corresponding to block 206 of FIG. 2). This figure will be explained below with reference to the graphical depictions of FIG. 7. The procedure 400 is performed by operating on the control points (q₀, q₁, q₂) of the original axis-symmetric control triangle provided via the procedure of FIG. 3.

In block 402, the system 100 displaces the control point q₀ outward along the normal to the extended curve segment Sₑ at point q₀ by a distance d. This defines a new control point q′₀. Alternatively, the system 100 can displace the control q₀ in the inward direction by a distance d.

Similarly, in block 404, the system 100 displaces the control point q₂ outward along the normal to the extended curve segment Sₑ at point q₂ by a distance d. This defines a new control point q′₂. Alternatively, the system 100 can displace the control q₂ in the inward direction by a distance d.

In block 406, the system 100 extends lines from the control points q′₀ and q′₂. The lines have slopes which match the original tangents lines at points q₀ and q₂, respectively. The intersection of the lines defines a new control point q′₁. Together, the control points q′₀, q′₁, and q′₂ define a new control triangle. The new control triangle, in turn, defines a quadratic approximate offset curve (based on the Bezier equation set forth above), having the properties described above.

More specifically, for cases in which the control points (q₀, q₁, q₂) are extended in the outward direction, the approximate offset curve can be guaranteed to lie at least a distance d from all points defined by the original curve segment Sₒ. The same is true for movement of the control points (q₀, q₁, q₂) in the inward direction, providing that the displacement of q₀ and q₂ does not extend beyond the axis a of the parabola.

Other techniques can be used to calculate the approximate offset curve. Hence, the particular operations shown in FIGS. 3 and 4 (as well as the particular sequence of operations) are to be understood as representative, not limiting.

Advancing to FIG. 5, this figure shows a procedure 500 for applying an approximate offset curve. This procedure 500 will be described with respect to the case in which a bounding region is defined with respect to a single approximate offset curve which is at least a distance d from an original curve segment Sₒ. But the same procedure 500 can be applied with respect to a bounding region defined by two or more approximate offset curves. Furthermore, the procedure 500 will be described with respect to a single instance of an original curve segment Sₒ and its corresponding approximate offset curve; but an application can apply the procedure 500 with respect to multiple instances of original curve segments and corresponding approximate offset curves. In some cases, the system 100 can calculate an approximate offset curve in advance, e.g., before it used in the procedure 500 of FIG. 5. In other cases, the system 100 can calculate the approximate offset curve in a dynamic manner, e.g., when it is needed by the procedure 500 of FIG. 5.

In block 502, the system 100 determines whether a query point lies in a region bounded by the approximate offset curve and the original curve system Sₒ. This operation can be performed by feeding the query point as an input into an implicit formula that is derived from the Bezier triangle defining the original curve segment Sₒ, and then feeding the query point as an input into an implicit formula that is derived from the Bezier triangle defining the approximate offset curve. For example, the system 100 can use the implicit equation described above to provide the implicit formulas. The outputs of the implicit equations indicate whether the query point lies in the region.

In block 506, if it is determined that the query point lies outside the region (as assessed in block 504), then the system 100 can avoid detailed analysis of this query point. In block 508, if it is determined that the query point lies within the region, then the system 100 can perform detailed analysis on this query point. For example, in one implementation, the system 100 can employ any iterative distance-determination technique to determine the minimum distance between the query point and the original curve segment Sₒ.

In block 510, the system 100 can perform a further application-specific action based on the output of block 508. For example, suppose that the query point represents a graphical display element (such as a pixel). The system 100 can modify an attribute of the graphical display element (such as a transparency value or a transverse parameter value) based on the distance of this element from the original curve segment Sₒ, e.g., in one case, so as to reduce the effects of aliasing.

The procedure 500 can be modified in different ways, e.g., by incorporating additional tests to determine whether the query point lies in the region bounded by the original curve segment Sₒ and the approximate offset curve. For example, the system 100 can also determine whether the query point lies in a rectangular bounding box defined by the x and y extremes of the original curve segment Sₒ, extended by a distance d. Alternatively, or in addition, the system 100 can also determine whether the query point lies within a prescribed distance from the endpoints of the original curve segment Sₒ, and so on. In this case, the procedure 500 can determine that a query point lies within the bounding region only if it satisfies the plural inclusion tests.

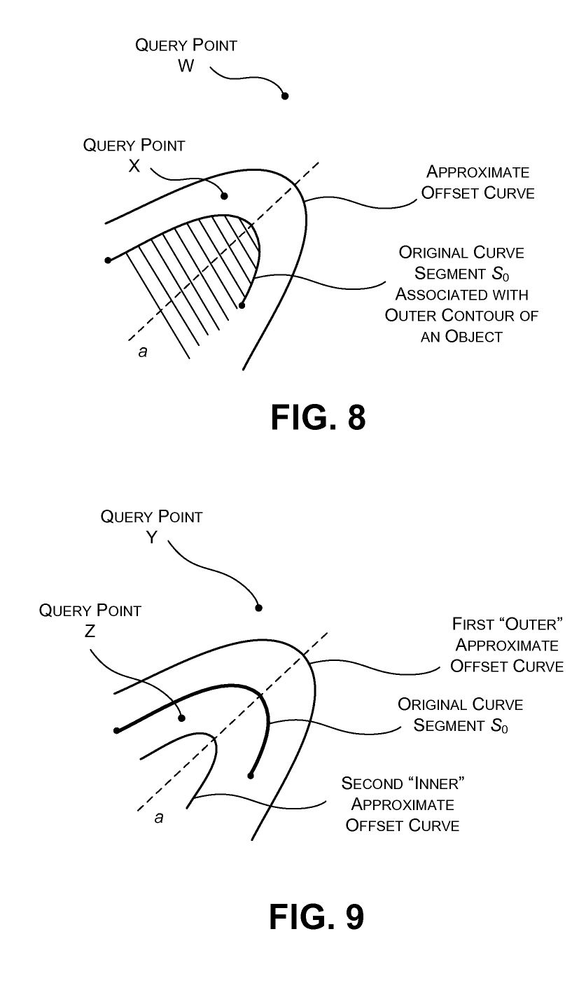

FIG. 8 is a graphical depiction of a first application of an approximate offset curve. Here, the original curve segment Sₒ defines a contour of some object, such as a graphical object (e.g., a font character, etc.). The approximate offset curve defines a region between the original curve segment Sₒ and the approximate offset curve, where, at all points, the approximate offset curve is at least distance d away from the original curve segment Sₒ. Based on the analysis of FIG. 5, the system 100 can determine that query point W lies outside this region and that query point X lies inside the region. The system 100 can then perform detailed analysis for query point X, but not query point W. For example, the system 100 can apply an anti-aliasing operation to modify an attribute of a pixel associated with query point X, but not a pixel associated with query point W.

FIG. 9 is a graphical depiction in which a first and second approximate offset curves bracket the original curve segment Sₒ, defining a region between the offset curves. Based on the analysis of FIG. 5, the system 100 can determine that a query point Y lies outside the region, and that query point Z lies within the region. The system 100 can then perform detailed analysis for query point Z, but not query point Y.

C. Representative Computing functionality

FIG. 10 sets forth illustrative computing functionality 1000 that can be used to implement any aspect of the functions described above. For example, the computing functionality 1000 can be used to implement any aspect of the system 100 of FIG. 1. In one case, the computing functionality 1000 may correspond to any type of computing device that includes one or more processing devices. In all cases, the electrical data computing functionality 1000 represents one or more physical and tangible processing mechanisms.

The computing functionality 1000 can include volatile and non-volatile memory, such as RAM 1002 and ROM 1004, as well as one or more processing devices 1006 (e.g., one or more CPUs, and/or one or more GPUs, etc.). The computing functionality 1000 also optionally includes various media devices 1008, such as a hard disk module, an optical disk module, and so forth. The computing functionality 1000 can perform various operations identified above when the processing device(s) 1006 executes instructions that are maintained by memory (e.g., RAM 1002, ROM 1004, or elsewhere).

More generally, instructions and other information can be stored on any computer readable medium 1010, including, but not limited to, static memory storage devices, magnetic storage devices, optical storage devices, and so on. The term computer readable medium also encompasses plural storage devices. In all cases, the computer readable medium 1010 represents some form of physical and tangible entity.

The computing functionality 1000 also includes an input/output module 1012 for receiving various inputs (via input modules 1014), and for providing various outputs (via output modules). One particular output mechanism may include a presentation module 1016 and an associated graphical user interface (GUI) 1018. The computing functionality 1000 can also include one or more network interfaces 1020 for exchanging data with other devices via one or more communication conduits 1022. One or more communication buses 1024 communicatively couple the above-described components together.

The communication conduit(s) 1022 can be implemented in any manner, e.g., by a local area network, a wide area network (e.g., the Internet), etc., or any combination thereof. The communication conduit(s) 1022 can include any combination of hardwired links, wireless links, routers, gateway functionality, name servers, etc., governed by any protocol or combination of protocols.

Alternatively, or in addition, any of the functions described in Sections A and B can be performed, at least in part, by one or more hardware logic components. For example, without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

In closing, the description may have described various concepts in the context of illustrative challenges or problems. This manner of explanation does not constitute an admission that others have appreciated and/or articulated the challenges or problems in the manner specified herein.

More generally, although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for producing an offset curve, implemented using tangible and physical computing functionality, comprising:
receiving data that describes an original control triangle, the original control triangle defining an original curve segment, the original curve segment, in turn, defining a portion of a parabola having an axis a;
constructing an original axis-symmetric control triangle based on the original control triangle, the original axis-symmetric control triangle being symmetric with respect to the axis a of the parabola;
constructing a new control triangle by adjusting positions of control points associated with the original axis-symmetric control triangle, the new control triangle also being symmetric with respect to the axis a of parabola, the new control triangle defining an approximate offset curve, and all points on the approximate offset curve being separated from all points on the original curve segment by at least a distance d; and
performing an application-specific action based on the approximate offset curve.

2. The method of claim 1, wherein the computing functionality comprises at least one processing device for processing instructions maintained in a computer-readable storage medium.

3. The method of claim 1, wherein said constructing of the new control triangle comprises moving the positions of the control points associated with the original axis-symmetric control triangle in an outward direction, such that the new control triangle is larger than the original axis-symmetric control triangle.

4. The method of claim 1, wherein said constructing of the new control triangle comprises moving the positions of the control points associated with the original axis-symmetric control triangle in an inward direction, such that the new control triangle is smaller than the original axis-symmetric control triangle.

5. The method of claim 1, wherein said constructing of the new control triangle comprises:
constructing a first new control triangle which defines a first approximate offset curve; and
constructing a second new control triangle which defines a second approximate offset curve.

6. The method of claim 5, wherein the original curve segment lies between the first approximate offset curve and the second approximate offset curve.

7. The method of claim 1, wherein the application-specific action comprises generating a graphical image based on at least the original curve segment and one or more corresponding approximate offset curves.

8. The method of claim 1, wherein the application-specific action comprises controlling a path taken by a machine based on at least the original curve segment and one or more corresponding approximate offset curves.

9. The method of claim 1, wherein said application specific action comprises:
receiving a query point;
determining whether the query point lies in a region bounded by the approximate offset curve and the original curve segment;
if the query point lies in the region, performing an analysis operation; and
if the query point does not lie in the region, avoiding the analysis operation.

10. The method of claim 9, wherein the analysis operation comprises determining a distance between the query point and the original curve segment using a distance-determination technique.

11. The method of claim 10, further comprising using the distance to perform an anti-aliasing operation within a graphical image.

12. The method of claim 10, further comprising using the distance to render a brushed path within a graphical image.

13. A system for producing and applying an offset curve, implemented using tangible and physical computing functionality, comprising:
an offset curve determination module for:
receiving data that describes an original control triangle, the original control triangle defining an original curve segment; and
producing an approximate offset curve based on the original control triangle, all points on the approximate offset curve being separated from all points on the original curve segment by at least a distance d, the original curve segment and the approximate offset curve each representing quadratic curves; and
an application module for performing an application-specific action based on the approximate offset curve.

14. The system of claim 13, wherein the offset curve determination module comprises:
a symmetric control triangle determination module for constructing an original axis-symmetric control triangle based on the original control triangle, the original axis-symmetric control triangle being symmetric with respect to an axis a of a parabola associated with the original curve segment; and
a control triangle extension module for constructing a new control triangle by adjusting positions of control points associated with the original axis-symmetric control triangle, the new control triangle also being symmetric with respect to the axis a of the parabola,
the new control triangle defining the approximate offset curve.

15. The system of claim 13, wherein the application-specific action comprises generating a graphical image based on at least the original curve segment and one or more corresponding approximate offset curves.

16. The system of claim 13, wherein the application-specific action comprises controlling a path taken by a machine based on at least the original curve segment and one or more corresponding approximate offset curves.

17. The system of claim 13, wherein the application module comprises:
a query point determining module for receiving a query point and determining whether the query point lies in a region bounded by the approximate offset curve and the original curve segment; and
an action-taking module for, if the query point lies in the region, determining a distance between the query point and the original curve segment using a distance-determination technique.

18. A computer readable storage medium for storing computer readable instructions, the computer readable instructions providing an offset curve determination module when executed by one or more processing devices, the computer readable instructions comprising:
logic configured to receive data that describes an original control triangle associated with control points p₀, p₁, and p₂, the original control triangle defining an original curve segment Sₒ;
logic configured to determine a line m which connects a midpoint of a line segment p₀p₂ to the control point p₁;
logic configured to draw a chord that is perpendicular to the line m which intersects an extended version of the original curve segment Sₒ twice, defining new control points q₀ and q₂;
logic configured to extend tangent lines at the new control points q₀ and q₂, yielding a new control point q₁ at an intersection of the tangent lines, the control points q₀, q₁, and q₂ together describing an original axis-symmetric control triangle; and
logic configured to displace the new control points (q₀, q₁, q₂) in an inward or outward direction to produce new control points (q′₀, q′₁, q′₂), the new control points (q′₀, q′₁, q′₂) defining a new control triangle and an associated approximate offset curve.

19. The computer-readable storage medium of claim 18, wherein the chord intersects either the control point p₀ or the control point p₂.

20. The computer-readable storage medium of claim 18, wherein the computer-readable instructions further implement an application module, the computer readable instructions comprising:
logic for receiving a query point and determining whether the query point lies in a region bounded by the approximate offset curve and the original curve segment; and
logic for, if the query point lies in the region, determining a distance between the query point and the original curve segment using a distance-determination technique.
